(19) United States
(12) Patent Application Publication
(10) Pub. No.: US 2015/0288880 A1
(43) Pub. Date: Oct. 8, 2015

(54) IMAGE CAPTURING METHOD AND IMAGE CAPTURING APPARATUS

(71) Applicant: Wu-Hsiung CHEN, Tainan City (TW)

(72) Inventor: Wu-Hsiung CHEN, Tainan City (TW)

(21) Appl. No.: 14/676,000

(22) Filed: Apr. 1, 2015

(30) Foreign Application Priority Data
Apr. 7, 2014 (TW) 103112661

(51) Int. Cl. H04N 5/232; H04N 5/225

(52) U.S. Cl. CPC H04N 5/23238; H04N 5/2257; H04N 5/2253; H04N 5/23293

(57) ABSTRACT

An image capturing method and an image capturing apparatus are disclosed. The image capturing method is performed by a carrier equipped with the image capturing apparatus. The image capturing apparatus has an image sensor and a panoramic scene acquirer capable of being moved out of and retracted into the carrier. The panoramic scene acquirer is moved out of the carrier of the carrier to correspond in position to the image sensor for capturing a surrounding scene for one time. Afterwards, the carrier produces a complete panoramic image or a partial image of the surrounding scene. Because the panoramic scene acquirer captures the surrounding scene for one time, time lag does not exist during the process of capturing the surrounding scene. Hence, the image shows the surrounding scene naturally.

### CROSS-REFERENCE TO RELATED APPLICATIONS

This application claims the benefit of Taiwan patent application No. 103112661, filed on Apr. 7, 2014, the disclosure of which is incorporated herein in its entirety by reference.

### BACKGROUND OF THE INVENTION

1. Field of the Invention

The present invention relates to an image capturing method and an image capturing apparatus, and more particularly to an image capturing method and an image capturing apparatus applicable to all kinds of carriers for providing more diversities in capturing a panoramic image.

2. Description of Related Art

A conventional image capturing apparatus applied to a carrier, such as a mobile phone and a tablet, has a function of capturing a panoramic image. A method to capture the panoramic image by using the image capturing apparatus having a single lens is to manually move the image capturing apparatus in a revolution. Meanwhile, the image capturing apparatus successively shoots multiple times to get multiple side-by-side original photos. Afterwards, an image processing means stitches the side-by-side original photos in series to form the panoramic image.

However, when the user moves the image capturing apparatus, appearance of the image is not ideal due to shakes and vibrations. Hence, a conventional electronic device is invented to overcome the problems resulting from the shakes and vibrations. The electronic device comprises a body part, a sensor part, and a light transmitting part. The light transmitting part is pivotally mounted in the body part. The light transmitting part can be turned to be aligned with an object and reflects an image of the object into the sensor part. Based on the rotatable light transmitting part, turning the light transmitting part instead of the body part can capture multiple side-by-side original photos. Hence, the user would not manually move the image capturing apparatus in a revolution. The problem caused from the user's shakes and vibrations is overcome.

Compared with the manual operation and revolution that the user moves the image capturing apparatus, the manual operation and revolution is replaced with the light transmitting part of the electronic device. The electronic device captures multiple side-by-side original photos at different shooting angles. The electronic device executes an image processing means to stitch the multiple side-by-side original photos in series to form the panoramic image. However, some shortcomings occur as listed below.

1. During view finding, the user holds the electronic device by hands. Shooting angles of the light transmitting part is changed one by one to capture multiple original photos. The problem of shakes and vibrations still exists and causes reduction of viewing range. In each capturing action, an assistant tool or software should be provided to the electronic device to secure the electronic device to solve the problem of shakes and vibrations.

2. During view finding, the image capturing apparatus sequentially captures multiple original photos at different shooting angles, such that the incoming lights entering the sensor part for the multiple photos are different. After the multiple original photos are stitched to form the panoramic image, junctions between each two adjacent original photos are easily observable and unnatural.

3. During view finding, the multiple original photos are captured at different timings. Time lag exists in each two adjacent photos. When a dynamic object is captured and located in a connecting side of a first original photo, due to the time lag, the dynamic object may not be located in a corresponding connecting side of a next second original photo, even is not captured in the second original photo at all. Hence, the panoramic image composed of the stitched photos has significant defects. The panoramic image fails to show the real surrounding scene at the capturing moment.

In conclusion, the conventional image capturing method has significant defects. The application of the conventional image capturing method is severely limited. For example, when the conventional method is for video recording, the obtained videos fail to display a scene at a moment, affecting the efficiency of the video conferences. Nowadays, in a video conference, a single camera device can be mounted on a particular position or several cameras can be respectively mounted on different positions to capture images from different areas. However, the single camera device fails to capture the panoramic image. The several cameras are inconvenient to operate and the images obtained by the cameras are not panoramic as well.

Moreover, conventional external-type panoramic image capturing devices, such as an external-type panoramic image capturing device equipped on a mobile phone or an external-type panoramic video camera device positioned on a table, are available in the market. However, the external-type panoramic image capturing device and the external-type panoramic video camera device respectively have shortcomings.

To bring the external-type panoramic image capturing device is inconvenient for the user. When the user forgets to bring the external-type panoramic image capturing device, the user can not capture the panoramic scene. In addition, an assembling tolerance between the mobile phone and the external-type panoramic image capturing device would affect the image capture, such that an image correction is needed before producing the panoramic image. For the external-type panoramic video camera device positioned on the table, the external-type panoramic video camera device is located on a particular position. Usage of the external-type panoramic video camera device is limited. Besides, the external-type panoramic video camera device is a heavy machine. It is inconvenient for the user to carry around the external-type panoramic video camera device. The conventional external-type panoramic image capturing device and the panoramic video camera device still have defects.

### SUMMARY OF THE INVENTION

Regarding the shortcomings, including the problems of manual shakes, vibrations, and the image correction, of the conventional image capturing method and the apparatus as mentioned above, an objective of the present invention is to provide an image capturing method and an image capturing apparatus to overcome the problems of defects resulting from using the conventional image capturing method and apparatus to produce the panoramic image. Further, the image capturing method and apparatus of the present invention can capture the surrounding scene for one single shoot. The carrier executes the image processing means to produce a complete panoramic image or a part of the panoramic image of the obtained surrounding scene, such that the panoramic image can display the natural and real surrounding scene at that capturing moment. According to the structure of a panoramic scene acquirer capable of being moved out of and retracted into the carrier, the panoramic scene acquirer would not affect the appearance of the carrier. Also, the carrier is easy to be carried around by the user and can be used directly. Compared with the external-type panoramic image capturing device of the prior art, the present invention has an advantage that the image correction is not needed in producing panoramic image. Further, a condition that a user forgets to bring some components and fails to use the external-type panoramic image capturing device would be avoided.

The image capturing method of the present invention is performed by a carrier having an image capturing apparatus. The image capturing apparatus comprises a panoramic scene acquirer and an image sensor having a lens. The panoramic scene acquirer is retractable into the carrier and can be positioned corresponding to the lens of the image sensor when the panoramic scene acquirer is moved out of the carrier. The method comprises:

moving the panoramic scene acquirer of the image capturing apparatus out of the carrier;

acquiring a surrounding scene for one time by the lens of the image sensor through the panoramic scene acquirer;

capturing the surrounding scene acquired from the lens by the image sensor controlled by the carrier, and transmitting an image of the surrounding scene from the image sensor to a control device of the carrier; and

real-time converting the image of the surrounding scene into a panoramic image, and displaying or storing a complete panoramic image or a part of the panoramic image for post-production by the control device of the carrier.

The image capturing apparatus of the present invention comprises:

an image sensor having a function of capturing an image, the image sensor having a lens; and

a panoramic scene acquirer mounted in a carrier, the panoramic scene acquirer being retractable into the carrier and positioned corresponding to the lens of the image sensor when the panoramic scene acquirer is moved out of the carrier.

The critical feature of the present invention is to mount an image capturing apparatus having an image sensor and an panoramic scene acquirer in the carrier. The panoramic scene acquirer is movably retracted into the carrier and can be positioned corresponding to the lens of the image sensor when the panoramic scene acquirer is moved out of the carrier. Hence, the image sensor can capture the surrounding scene for one single capture via the panoramic scene acquirer. The present invention does not have problem in image correction and carriage.

### BRIEF DESCRIPTION OF THE DRAWINGS

FIG. 1 is a flow chart of an embodiment of the image capturing method of the present invention;

FIG. 2 is a schematic view of a first embodiment of the image capturing apparatus of the present invention applied to a carrier, wherein the panoramic scene acquirer is retracted into the carrier;

FIG. 3 is an operational view showing that the panoramic scene acquirer of FIG. 2 is moved out of the carrier;

FIG. 4 is a partial view of FIG. 3;

FIG. 5 is an operational view of the first embodiment of the image capturing apparatus applied to a mobile phone;

FIG. 6 is a schematic view of a second embodiment of the image capturing apparatus of the present invention applied to a carrier, wherein the panoramic scene acquirer is retracted into the carrier;

FIG. 7 is an operational view showing that the panoramic scene acquirer of FIG. 2 is moved out of the carrier;

FIG. 8 is a partial view of FIG. 7;

FIG. 9 is a schematic view of a third embodiment of the image capturing apparatus of the present invention applied to a carrier, wherein the panoramic scene acquirer is retracted into the carrier;

FIG. 10 is an operational view showing that the image sensor of FIG. 9 is simultaneously moved with the panoramic scene acquirer;

FIG. 11 is a schematic view of a fourth embodiment of the image capturing apparatus of the present invention applied to a carrier, wherein the panoramic scene acquirer is retracted into the carrier; and

FIG. 12 is an operational view showing that the image sensor of FIG. 11 is moved and the panoramic scene acquirer of FIG. 11 is moved out of the carrier.

### DETAILED DESCRIPTION OF THE PREFERRED EMBODIMENT

The present invention includes an image capturing method and an image capturing apparatus that are applicable for all kinds of carriers. The carrier can be an individual gadget, such as a mobile phone, a tablet, and a notebook computer. The present invention can be mounted on a carrier equipped on all kinds of immobile equipments or mobile equipments. The image capturing method is performed by the image capturing apparatus. The image capturing apparatus comprises an image sensor and a panoramic scene acquirer. The panoramic scene acquirer is movably mounted in the carrier. The panoramic scene acquirer can be retracted into the carrier. The panoramic scene acquirer can be positioned when the panoramic scene acquirer is moved out of the carrier, such that a position of the image sensor corresponds to a position of the panoramic scene acquirer for capturing a surrounding scene for one time. The image sensor has a lens. The image sensor can be fixed in a particular position in the carrier, can be simultaneously moved with the panoramic scene acquirer, or can be independently moved to a position that corresponds to the panoramic scene acquirer. When the image sensor and the panoramic scene acquirer are moved separately, moving mode or moving distances of them can be the same or different.

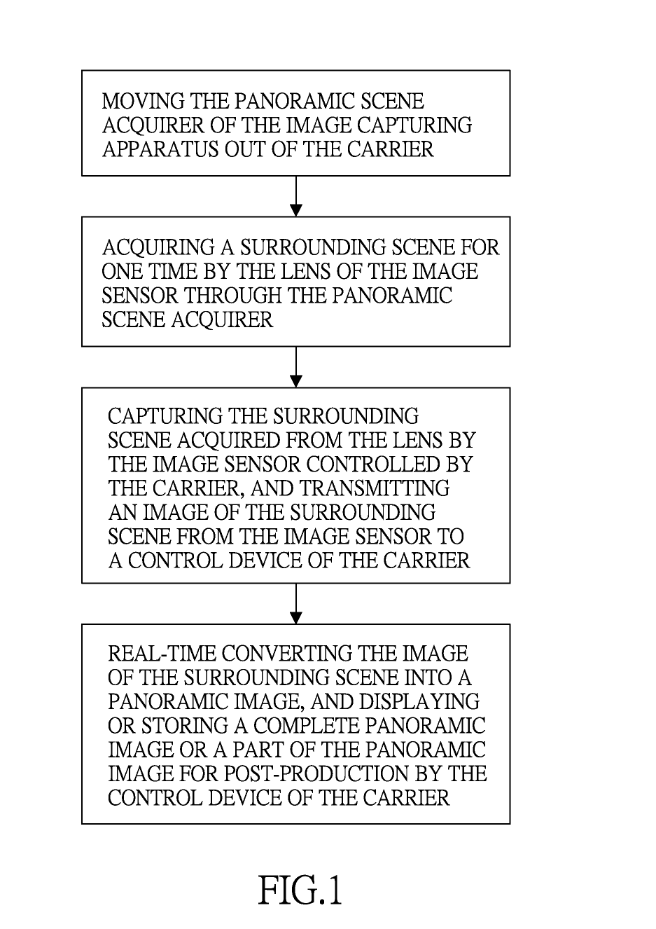

The image capturing method and the image capturing apparatus of the present invention are described as the following. With reference to FIG. 1, the image capturing method comprises the steps of:

moving the panoramic scene acquirer of the image capturing apparatus out of a carrier;

acquiring a surrounding scene for one time by the lens of the image sensor through the panoramic scene acquirer;

capturing the surrounding scene acquired from the lens by the image sensor controlled by the carrier, and transmitting an image of the surrounding scene from the image sensor to a control device of the carrier; and

real-time converting the image of the surrounding scene into a panoramic image, and displaying or storing a complete panoramic image or a part of the panoramic image for post-production by the control device of the carrier.

The complete panoramic image or a part of the complete panoramic image can be simultaneously displayed on a display module, such as a display, of the carrier for video conferences, can be either recorded dynamic or static images, and can be applied to post-production process.

The image capturing method captures the surrounding scene for one time without time lag. Hence, the panoramic image produced by the method of the present invention shows a natural, real, and panoramic scene at a moment. For video conferences, the panoramic image can show a real-time condition of the surroundings. For memorable images or recorded images, because the panoramic image is captured for one time instead of being stitched from multiple photos captured at different timings, impacts of dynamic objects or shadows on stitching junction would not exist to affect the quality of the panoramic image, such that the panoramic image can naturally show the panoramic scene. According to the structure of the panoramic scene acquirer capable of being moved out of and retracted into the carrier, the panoramic scene acquirer would not affect the appearance of the carrier. Also, the carrier is easy to be carried around with the user and can be used directly. Compared with the different external-type panoramic image capturing devices as mentioned in the prior art, the present invention has an advantages that the image capturing apparatus is easy to be carried around with the user and the image correction is not needed. Further, a condition that a user forgets to bring some components and fails to use the external-type panoramic camera device would be avoided.

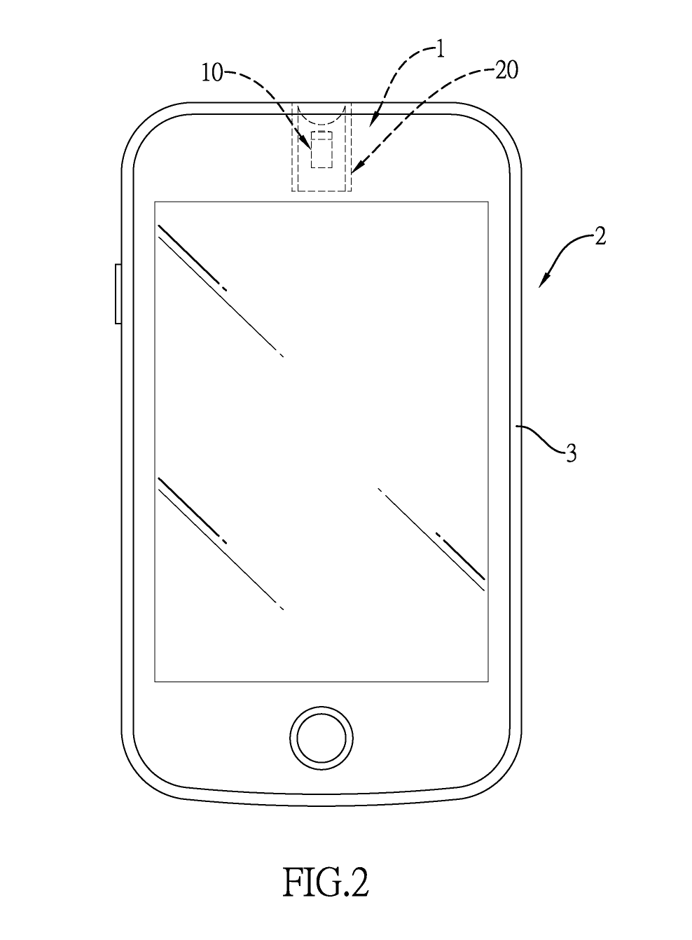

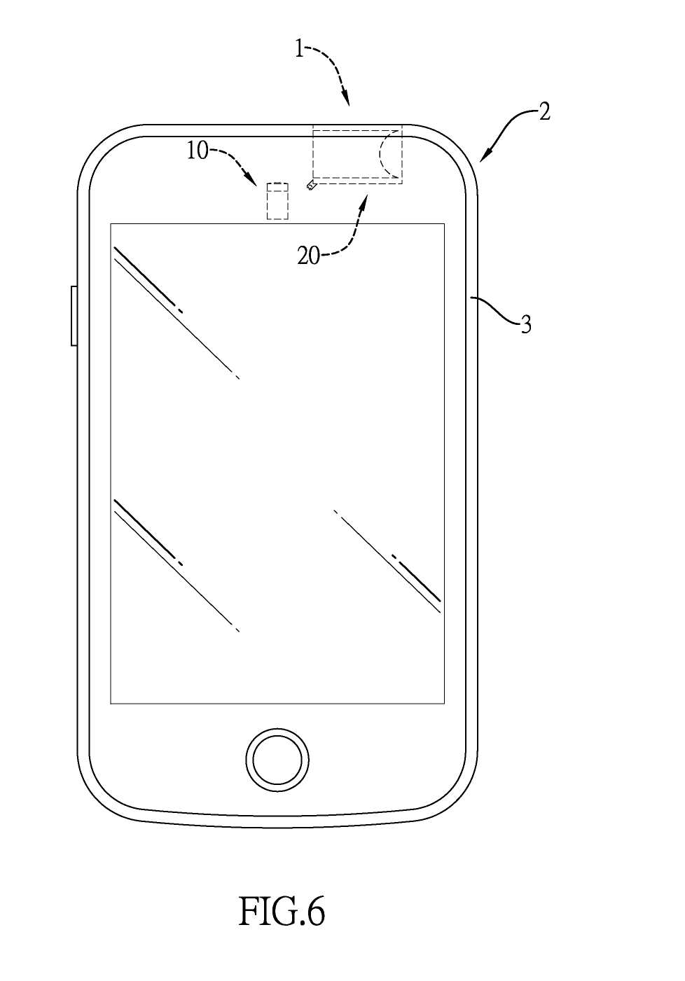

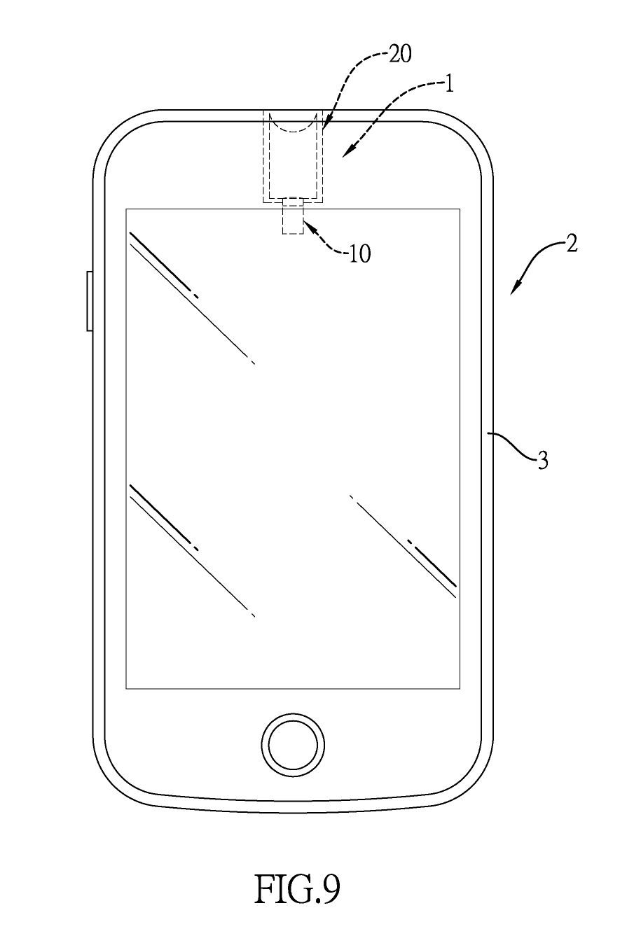

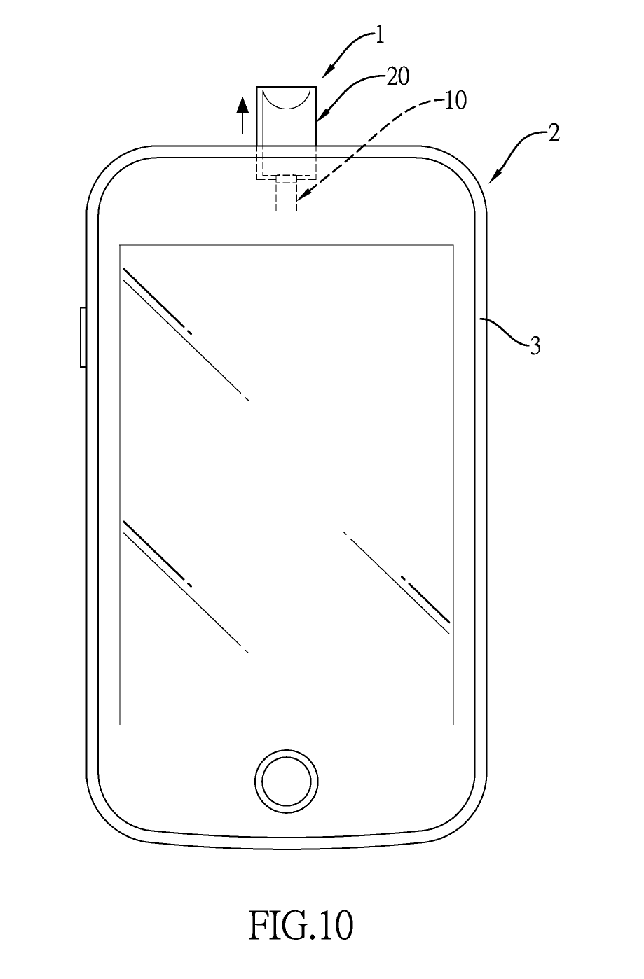

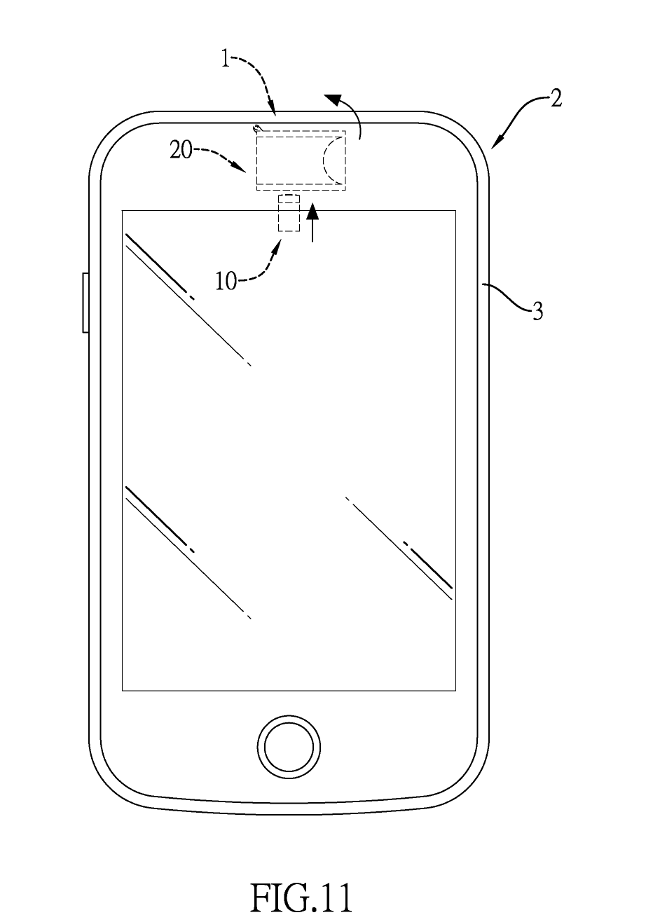

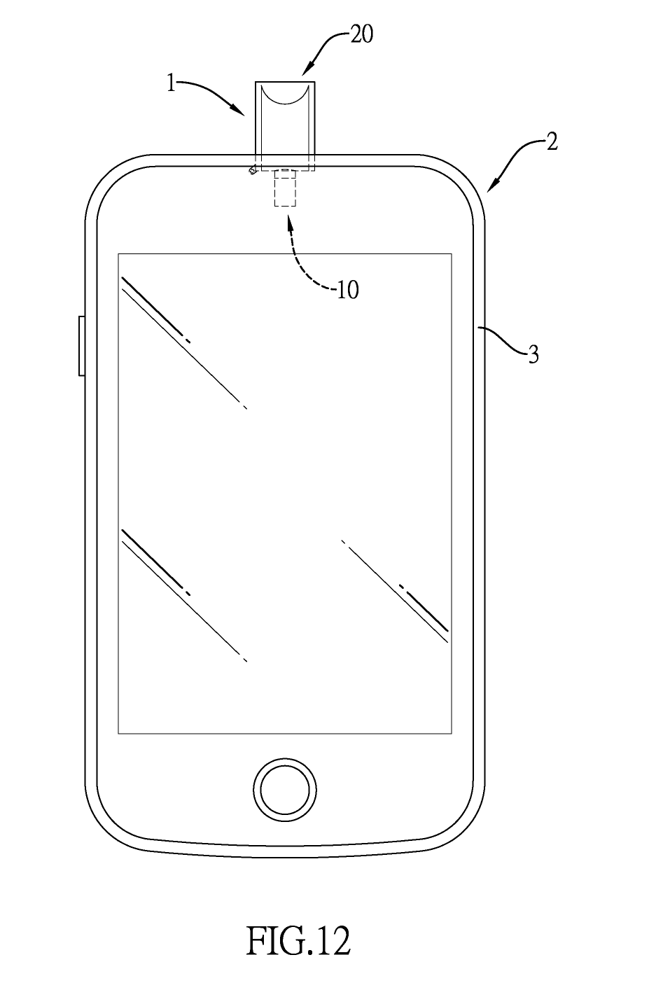

The image capturing method can be performed by the image capturing apparatus of the present invention. The image capturing apparatus can be pervasively applied to all kinds of carriers and has multiple embodiments as disclosed in FIGS. 2-12, wherein a mobile phone is as an example of the carrier. A first embodiment of the image capturing apparatus is disclosed in FIGS. 2-5. The panoramic scene acquirer is independently and linearly movable. A second embodiment of the image capturing apparatus is disclosed in FIGS. 6-8. The panoramic view acquirer is independently rotatable. A third embodiment of the image capturing apparatus is disclosed in FIGS. 9 and 10. The image sensor and the panoramic scene acquirer are simultaneously and linearly movable with each other. A fourth embodiment of the image capturing apparatus is disclosed in FIGS. 11 and 12. The image sensor and the panoramic scene acquirer are moved separately, wherein the panoramic scene acquirer is rotatable and the image sensor is linearly movable.

With reference to FIGS. 2-5, the image capturing apparatus 1 of the present invention comprises an image sensor 10 and a panoramic scene acquirer 20. The image sensor 10 can be a charge-coupled device (CCD) or other devices having equivalent function of image capturing, such as a complementary metal-oxide semiconductor (CMOS). The image sensor 10 comprises a lens 11. The image sensor 10 captures an image through the lens 11. The image sensor 10 is fixed in the case 3 of the carrier 2. The carrier 2 controls the image sensor 10 to capture an image.

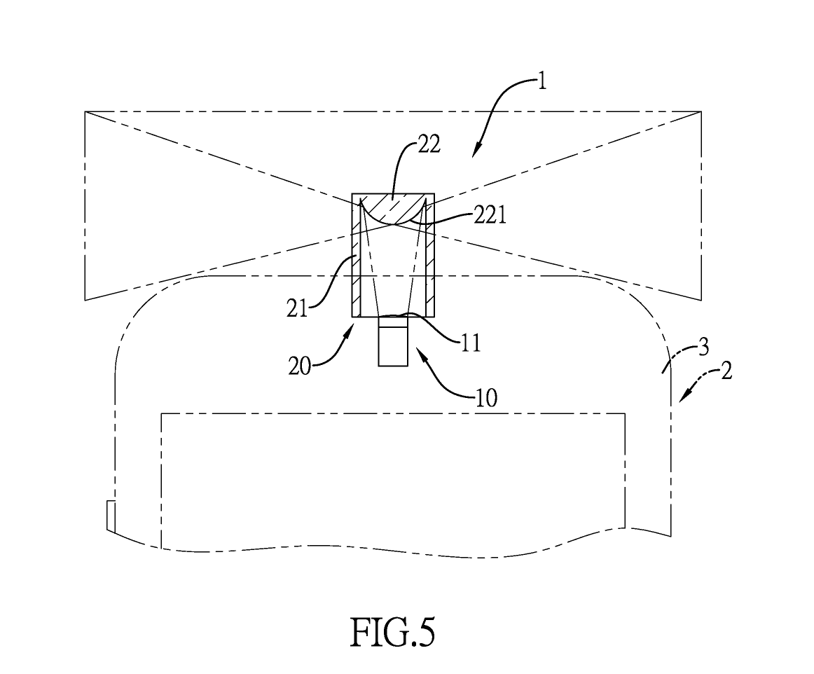

The panoramic scene acquirer 20 is made of transparent glass, acrylic, or other transparent materials. The panoramic scene acquirer 20 can be totally transparent, or partially transparent at the portion that protrudes from the case 3 of the carrier 2. With reference to FIG. 5, the panoramic scene acquirer 20 is mounted in the case 3 of the carrier 2. The panoramic scene acquirer 20 has a function of reflecting lights. For example, the panoramic scene acquirer 20 comprises a curved body 22 with light reflecting function, or further comprises a support 21. The curved body 22 comprises a curved reflective surface 221 formed on a sphere, a paraboloid, a hyperboloid, or a conical surface. The panoramic scene acquirer 20 is mounted in front of the lens 11 of the image sensor 10. A position of the curved reflective surface 221 corresponds to a position of the lens 11. A central axis of the lens 11 of the image sensor 10 can correspond to or skew off a center of the curved reflective surface 221. The support 21 comprises a first terminal and a second terminal. The curved body 22 is mounted in the second terminal. The curved reflective surface 221 faces toward the first terminal of the support 21. The support 21 can be a transparent tube.

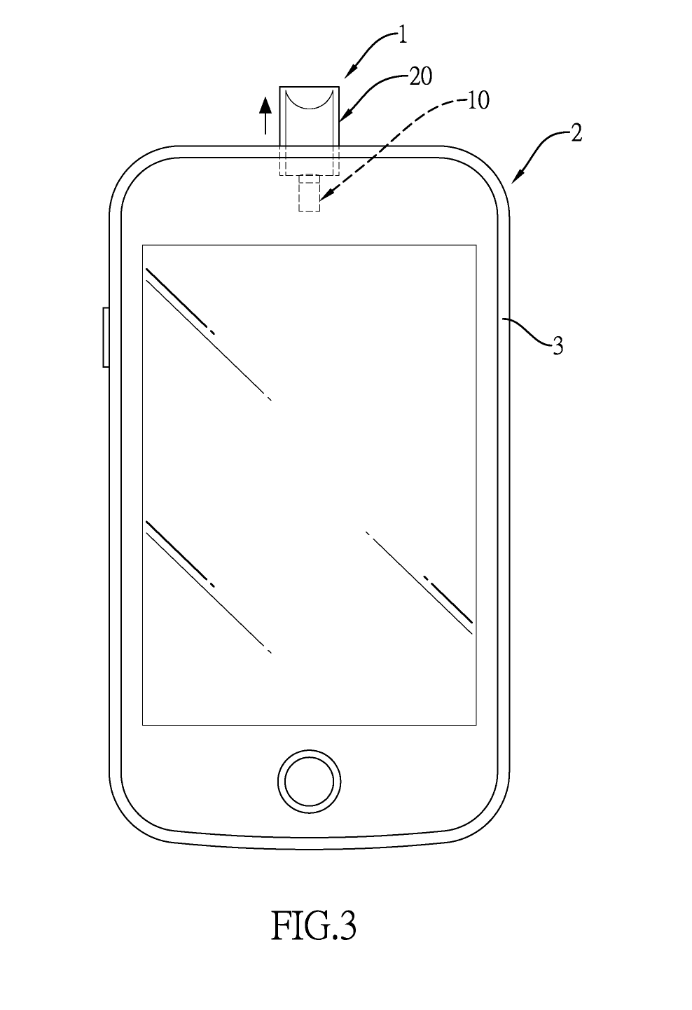

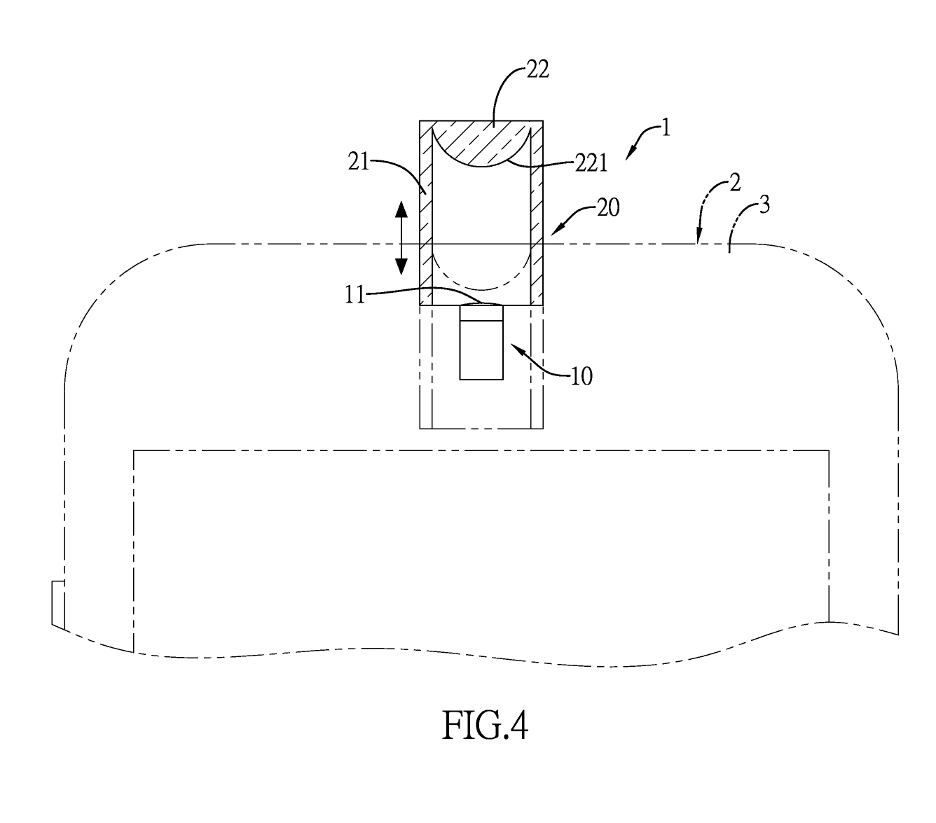

With reference to FIGS. 3 and 4, in the first embodiment of the image capturing apparatus, the panoramic scene acquirer 20 is mounted in the case 3 of the carrier 2 and is linearly movable in front of the lens 11 of the image sensor 10. With reference to FIG. 2, when the panoramic scene acquirer 20 is not in use, the panoramic scene acquirer 20 is retracted in the case 3 of the carrier 2. The linear movement of the panoramic scene acquirer 20 can be performed by manual push/pull, a linear driving device, or a press cylinder mounted on a side of the case 3. For example, the linear driving device includes a motor, gears, and racks driven by the motor.

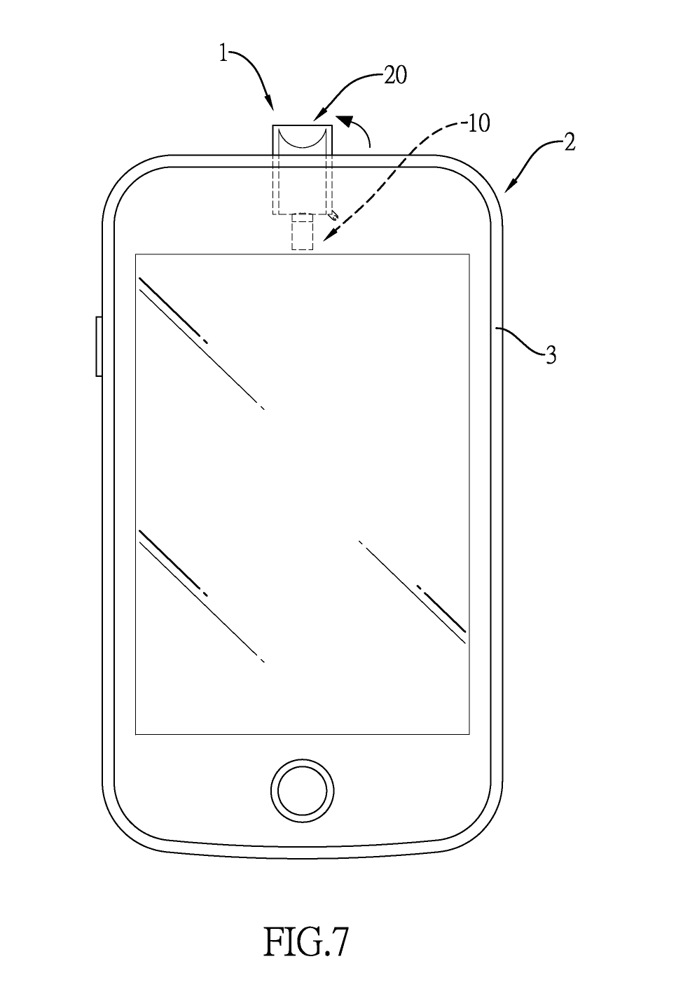

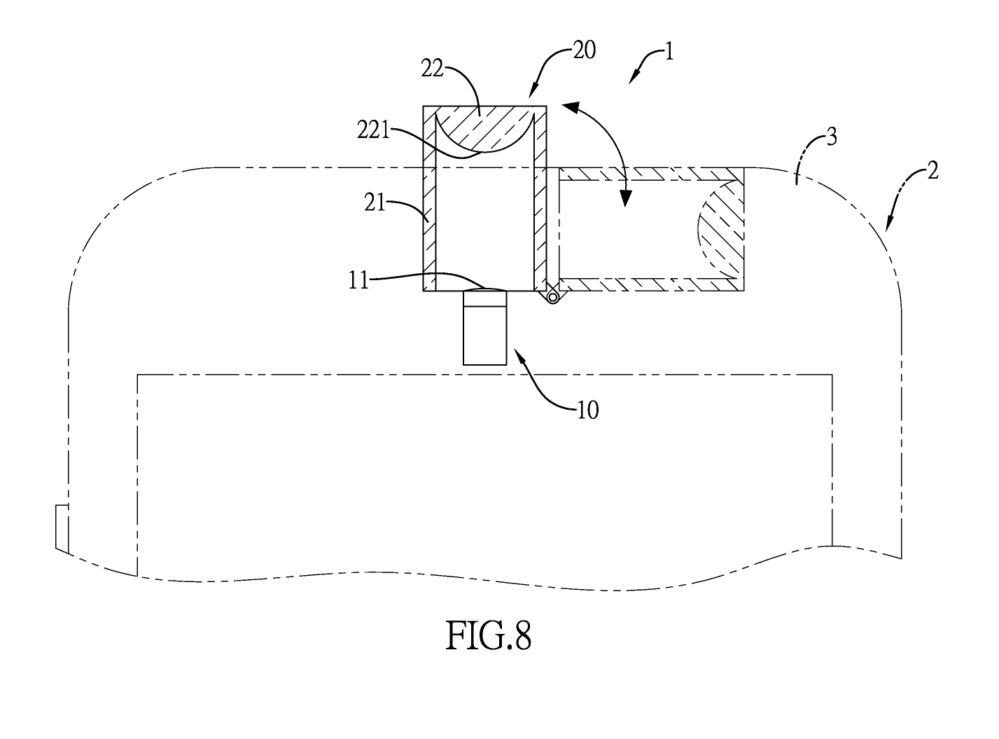

With reference to FIGS. 6-8, in the second embodiment of the image capturing apparatus, the panoramic scene acquirer 20 is pivotally moved in the case 3. With reference to FIG. 6, the panoramic scene acquirer 20 is retracted in the case 3. With reference to FIGS. 7-8, after the panoramic scene acquirer 20 is rotated out from the case 3, the curved body 22 of the panoramic scene acquirer 20 is located on exterior of the case 3 of the carrier 2 and the image sensor 10 corresponds in position to the panoramic scene acquirer 20, such that the image sensor 10 outwardly captures a panoramic image via the panoramic scene acquirer 20 for one time. The rotary movement of the panoramic scene acquirer 20 can be performed by manual push/pull, a rotary-type driving device, or a rotary-type press cylinder. For example, the rotary-type driving device includes a motor and a speed reducer cooperated with the motor.

With reference to FIGS. 9-10, in the third embodiment of the image capturing apparatus, the image sensor 10 is fixed to the panoramic scene acquirer 20, such that the image sensor 10 is simultaneously movable with the panoramic scene acquirer 20. Relative position between the image sensor 10 and the panoramic scene acquirer 20 is retained. When the panoramic scene acquirer 20 linearly moves, the image sensor 10 linearly moves simultaneously with the panoramic scene acquirer 20.

With reference to FIGS. 11-12, in the fourth embodiment of the image capturing apparatus, the image sensor 10 and the panoramic scene acquirer 20 are moved separately. The image sensor 10 and the panoramic scene acquirer 20 can be positioned in an alignment status as shown in FIG. 12. The panoramic scene acquirer 20 is rotatable in the case 3 and the image sensor 10 is linearly movable in the case 3 to form the alignment status as shown in FIG. 12.

The above disclosure just provides four different embodiments showing various structures of the image sensor 10 and the panoramic scene acquirer 20. A critical feature of the present invention is that the panoramic scene acquirer is movably retracted in the carrier or is positioned corresponding to the lens 11 of the image sensor 10 when the panoramic scene acquirer 20 is moved out of the case 3. Any embodiment conforming to the critical feature of the present invention is included in the inventive range of the present invention.

The first embodiment of the present invention is further elaborated in this paragraph. With reference to FIGS. 2-5, when the image capturing apparatus of the present invention is applied to the carrier for capturing the panoramic scene, the panoramic scene acquirer 20 of the image capturing apparatus 1 is moved out of the case 3 of the carrier 2 at first, such that the curved body 22 with the curved reflective surface 221 is at exterior of the case 3. The curved reflective surface 221 of the panoramic scene acquirer 20 refracts a panoramic scene of the surroundings toward the lens 11 of the image capturing 10. The carrier 2 controls the image sensor 10 to capture an image signal formed in the lens 11. The image signal is transmitted to the control device of the carrier 2. The control device of the carrier 2 converts the image signal into a complete panoramic image signal or a partial panoramic image signal through an image processing means to produce a complete panoramic image or a partial panoramic image.

In conclusion, the image capturing apparatus is a combination of the image sensor and a panoramic scene acquirer and is adapted to be mounted in a carrier. The panoramic scene acquirer can be movably retracted into the carrier or be positioned corresponding to the lens of the image sensor when the panoramic scene acquirer is moved out of the carrier for providing a function of capturing the panoramic scene for one time. The structure of the panoramic scene acquirer capable of being moved out of and retracted into the carrier, the panoramic scene acquirer would not affect the appearance of the carrier. Therefore, the panoramic image produced by the present invention is real and natural. Further, the present invention can be equipped on all kinds of carriers to promote the convenience in capturing the panoramic image. An objective to capture a real-time panoramic image is accomplished. Also, the carrier is easy to be carried around by the user and can be used directly. The image capturing apparatus is a module for being applied to or built in all kinds of carriers. Compared with the different external-type panoramic camera devices of the prior art, the present invention has an advantages that the image capturing apparatus is easy to be carried around with the user and the image correction is not needed. Further, a condition that a user forgets to bring some components and fails to use the external-type panoramic camera device would be avoided.

What is claimed is:

1. An image capturing method performed by a carrier having an image capturing apparatus, the image capturing apparatus comprising a panoramic scene acquirer and an image sensor having a lens, the panoramic scene acquirer being retractable into the carrier, and positioned corresponding to the lens of the image sensor when the panoramic scene acquirer is moved out of the carrier, the method comprising:
moving the panoramic scene acquirer of the image capturing apparatus out of the carrier;
acquiring a surrounding scene for one time by the lens of the image sensor through the panoramic scene acquirer;
capturing the surrounding scene acquired from the lens by the image sensor controlled by the carrier, and transmitting an image of the surrounding scene from the image sensor to a control device of the carrier; and
real-time converting the image of the surrounding scene into a panoramic image, and displaying or storing a complete panoramic image or a part of the panoramic image for post-production by the control device of the carrier.

2. An image capturing apparatus comprising:
an image sensor having a function of capturing an image, the image sensor having a lens; and
a panoramic scene acquirer mounted in a carrier, the panoramic scene acquirer being retractable into the carrier and positioned corresponding to the lens of the image sensor when the panoramic scene acquirer is moved out of the carrier.

3. The apparatus as claimed in claim 2, wherein the panoramic scene acquirer is linearly movable in the carrier.

4. The apparatus as claimed in claim 2, wherein the panoramic scene acquirer is pivotally movable in the case of the carrier.

5. The apparatus as claimed in claim 3, wherein the image sensor is fixed in the carrier.

6. The apparatus as claimed in claim 4, wherein the image sensor is fixed in the carrier.

7. The apparatus as claimed in claim 3, wherein the image sensor simultaneously moves with the panoramic scene acquirer.

8. The apparatus as claimed in claim 4, wherein the image sensor simultaneously moves with the panoramic scene acquirer.

9. The apparatus as claimed in claim 3, wherein the image sensor and the panoramic scene acquirer are moved separately.

10. The apparatus as claimed in claim 4, wherein the image sensor and the panoramic scene acquirer are moved separately.

11. The apparatus as claimed in claim 3, wherein the panoramic scene acquirer is transparent and comprises a reflective curved body.

12. The apparatus as claimed in claim 3, wherein the panoramic scene acquirer is transparent and comprises a reflective curved body.
